(19) United States
(12) Patent Application Publication
(10) Pub. No.: US 2014/0364234 A1
(43) Pub. Date: Dec. 11, 2014

(54) CONTROLLING COMMUNITY WAGERING GAMES

(71) Applicant: WMS Gaming, Inc., Waukegan, IL (US)

(72) Inventors: Jesse M. Smith, Chicago, IL (US); Craig J. Sylla, Round Lake, IL (US); Jamie W. Vann, Chicago, IL (US)

(21) Appl. No.: 14/302,092

(22) Filed: Jun. 11, 2014

Related U.S. Application Data
(60) Provisional application No. 61/833,682, filed on Jun. 11, 2013.

(51) Int. Cl. G07F 17/32

(52) U.S. Cl. CPC G07F 17/3209; G07F 17/3276
USPC 463/37

(57) ABSTRACT

A wagering game system and its operations are described herein. In some embodiments, the operations can include initiating a community wagering game associated with a bank of wagering game machines, where a wagering game machine, from the bank of wagering game machines, is associated with a hand-held game controller configured to control game play for the community wagering game. The operations can further include selecting a second game controller, associated with the wagering game machine, as an alternative to the hand-held game controller for the community wagering game. The operations can further include enabling the second game controller to control at least a portion of the game play for the community wagering game.

### RELATED APPLICATIONS

This application claims the priority benefit of U.S. Provisional Application Ser. No. 61/833,682 filed Jun. 11, 2013.

### LIMITED COPYRIGHT WAIVER

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2014, WMS Gaming, Inc.

### TECHNICAL FIELD

Embodiments of the inventive subject matter relate generally to wagering game systems and networks that, more particularly, control community wagering games.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

Some wagering game providers provide a variety of types of wagering games. Some types of wagering games include group games, also referred to as community wagering games. The community wagering games (“community games”) are associated with a bank of wagering game machines. For example, a group of players sit at a group of similarly themed wagering game machines that are grouped in a local network. The group of similarly themed wagering game machines are typically located near each other geographically (e.g., adjacent to each other in a specific location of a casino). Some banks share a common group display which is used to present content for the community game. Community games add to the fun and excitement of wagering games.

### BRIEF DESCRIPTION OF THE DRAWING(S)

Embodiments are illustrated in the Figures of the accompanying drawings in which:

FIG. 1 is an illustration of controlling community wagering games with hand-held devices associated with a bank of wagering game machines, according to some embodiments;

FIG. 2 is a flow diagram 200 illustrating providing alternate control mechanisms for a community wagering game, according to some embodiments;

FIG. 3 is a flow diagram 300 illustrating determining whether alternate control mechanisms are required for a community wagering game, according to some embodiments;

FIG. 4 is an illustration of providing options related to use of a hand-held control device for a community wagering game, according to some embodiments;

FIG. 5 is an illustration of providing options related to selection of an alternate control mechanism for a community wagering game, according to some embodiments;

FIG. 6 is an illustration of providing alternate control mechanisms in a community wagering game, according to some embodiments;

FIG. 7 is an illustration of a wagering game system 700 used for a community wagering game, according to some embodiments;

FIG. 8 is an illustration of a wagering game system architecture 800, according to some embodiments;

FIG. 9 is an illustration of a wagering game machine architecture 900, according to some embodiments; and

FIG. 10 is an illustration of a wagering game system 1000, according to some embodiments.

### DESCRIPTION OF ILLUSTRATIVE EMBODIMENTS

This description of the embodiments is divided into four sections. The first section provides an introduction to embodiments. The second section describes example operations performed by some embodiments while the third section describes example operating environments. The fourth section presents some general comments.

### INTRODUCTION

This section provides an introduction to some embodiments.

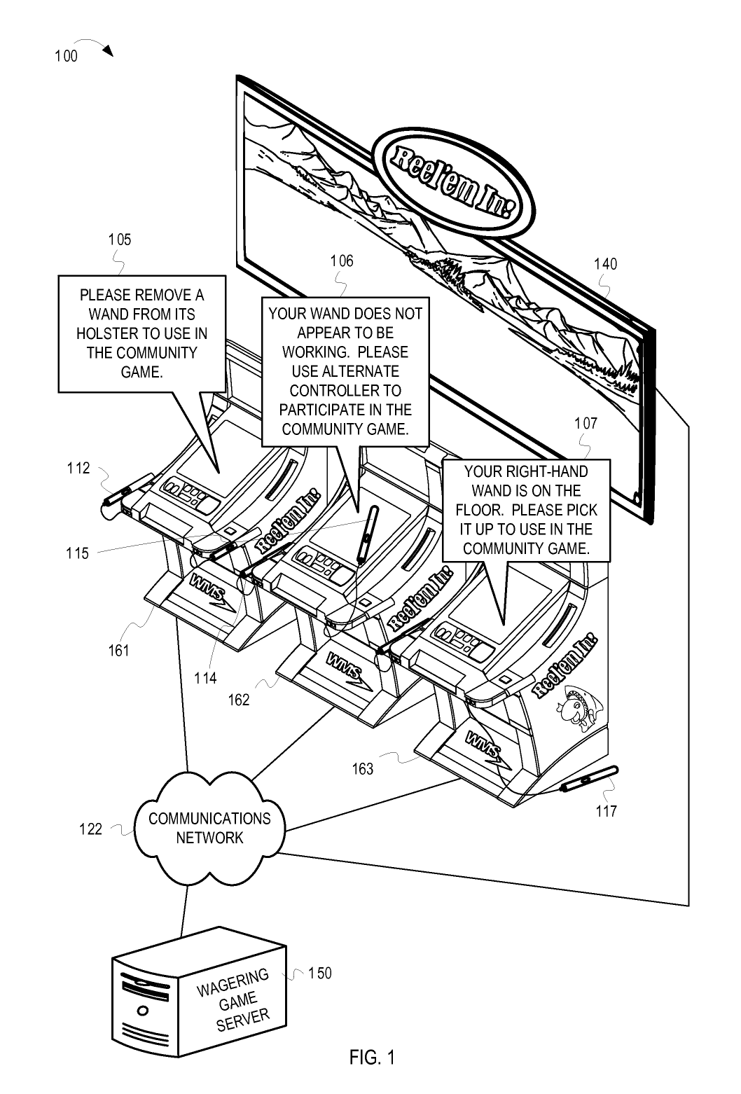

FIG. 1 is a conceptual diagram that illustrates an example of controlling community wagering games with hand-held devices associated with a bank of wagering game machines, according to some embodiments. In FIG. 1, a wagering game system (“system”) 100, includes a bank of wagering game machines 161, 162, and 163 (“wagering game machines 161-163”) connected to a wagering game server 150 via a communications network 122. The wagering game machines 161-163 provide a similarly themed wagering game (e.g., the wagering game machines 161-163 all present the REEL'EM IN® wagering game by WMS Gaming Inc.). The wagering game provided via the wagering game machines 161-163 may be referred to as a primary wagering game, or “base” game, which different players can play in separate wagering game sessions. Occasionally, an event occurs that causes a community game to begin. An overhead display 140 is also connected to the communications network 122. The display 140 presents content for the community game. For example, for the community game more than one of the players at the wagering game machines 161-163 can control virtual objects depicted on the display 140. For example, a player can cast a virtual fishing line into a virtual representation of a lake (depicted on the display 140). Each player at each individual one of the wagering game machines 161-163, can cast their virtual fishing line using a game controller individually associated with the individual one of the wagering game machines 161-163. For instance, wagering game machine 161 is associated with a hand-held game controller (“hand-held device”) 112 that a player can hold by hand and move according to specific game rules and game mechanics. For instance, a player can hold the hand-held device 112 in the air. A motion detection unit is included in the hand-held device 112, which detects motion of the hand-held device 112 and communicates data about the motion (“motion data”) to the wagering game server 150. The wagering game server 150 uses the motion data for the hand-held device 112 to create a depiction of a fishing line object via the display 140. The wagering game server 150 also randomly selects a wagering game outcome based on where the player casts the fishing line object into the virtual lake depicted in the display 140. The wagering game server 150 can then, based on the wagering game outcome, pay out to the player a specific amount of money, or some other prize, for the community game. For instance, the wagering game server 150 can randomly select a wagering game outcome that either shows that the player has caught a virtual fish, with a random monetary value associated with the fish. The wagering game server 150 can then award the monetary value to the player (e.g., add the monetary value to a session credit balance shown on the wagering game machine 161 and/or add the monetary value credit balance of a wagering game player account).

When the system 100 initiates the community game, the system 100 may detect that one or more of the hand-held devices associated with the wagering game machines 161-163 are either non-functional (e.g., malfunctioning) or not being used as intended, or expected, to participate in the community game. The system 100 can provide various helps and incentives to use the hand-held devices. The system 100 can also provide alternatives for the player to use or select in case the hand-held devices are malfunctioning or if the user indicates a request to use different controllers. Therefore, the system 100 provides support for, and alternatives to, controlling the community game with the hand-held devices. For example, system 100 detects that, after the community game is initiated, the player has not picked up any of the hand-held devices associated with the wagering game machine 161. As a result, the system 100 provides a notification 105 reminding the player to remove the hand-held device 112 from its holding location (e.g., the hand-held device 112 may be referred to as a “wand” device because it has a shape and function similar to a wand). The system 100 can also provide a tutorial, or help screens, to show the player how to use the hand-held device 112 for the community game.

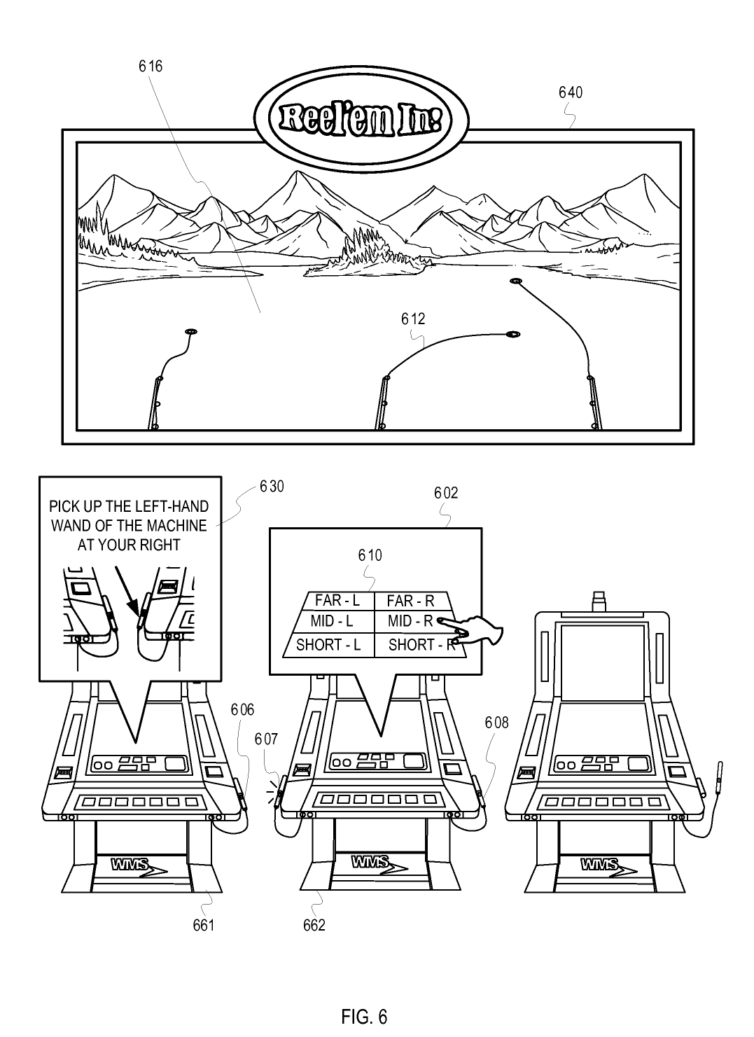

In another example, the system detects a potential malfunction in one of the hand-held devices. For instance, the system 100 detects that one of the hand-held devices (e.g., “hand-held device 114”) at the wagering game machine 162 is removed from its holding receptacle, but the wagering game server 150 does not detect any type of motion input from the hand-held device 115. Consequently, the system 100 determines that the held-held device 115 is non-functional. Thus, the system 100 provides a notification 106 for the player to select an alternative controller to participate in the community game. For instance, the system 100 may suggest that a second hand-held device 114 be used. The system 100 may also, or instead, provide a list of alternative game controllers other than hand-held devices attached to the wagering game machine 162. The list of alternative game controllers may include, but is not limited to, a button panel on the wagering game machine 162, a touch-screen display of the wagering game machine 162, controls on a chair attached to the wagering game machine 162, etc. FIG. 6 below describes some example alternatives according to some embodiments.

In another example, upon initiation of the community game, the system 100 detects, that a hand-held device 117 for the wagering game machine 163 is in a location that is not likely to be recognized by a player at the wagering game machine 163 (e.g., outside of a user's current view). The system can detect a location of the hand-held device 117 based on information provided by a location tracking unit in the hand-held device 117. The system 100 can further determine a field of view of a player at the wagering game machine 163 by player tracking devices associated with the player (e.g., a tracking module stored on a player card or smartphone), with the wagering game machine 163 (e.g., eye tracking devices associated with the wagering game machine 163), or elsewhere (e.g., cameras located in the casino). Therefore, the system 100 provides a notification 107 that indicates a physical location of the hand-held device 117 relative to the wagering game machine 163 (e.g., the notification 107 indicates that the hand-held device 117 is on the floor next to the wagering game machine 163).

Further, some embodiments of the inventive subject matter describe examples of controlling community wagering games in a network wagering venue (e.g., an online casino, a wagering game website, a wagering network, etc.) using a communication network, such as the communications network 122 in FIG. 1. Embodiments can be presented over any type of communications network that provides access to wagering games, such as a public network (e.g., a public wide-area-network, such as the Internet), a private network (e.g., a private local-area-network gaming network), a file sharing network, a social network, etc., or any combination of networks. Multiple users can be connected to the networks via computing devices. The multiple users can have accounts that subscribe to specific services, such as account-based wagering systems (e.g., account-based wagering game websites, account-based casino networks, etc.).

Further, for purposes of the present detailed description, a user may be referred to as a player (i.e., of wagering games), and a player may be referred to interchangeably as a player account. Account-based wagering systems utilize player accounts when transacting and performing activities, at the computer level, that are initiated by players. Therefore, a “player account” represents the player at a computerized level. The player account can perform actions via computerized instructions. For example, in some embodiments, a player account may be referred to as performing an action, controlling an item, communicating information, etc. Although a player, or person, may be activating a game control or device to perform the action, control the item, communicate the information, etc., the player account, at the computer level, can be associated with the player, and therefore any actions associated with the player can also be associated with the player account. Therefore, for brevity, to avoid having to describe the interconnection between player and player account in every instance, a “player account” may be referred to herein in either context. Further, in some embodiments herein, the word “gaming” is used interchangeably with “gambling.”

Furthermore, for purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Although FIG. 1 describes some embodiments, the following sections describe many other features and embodiments.

### Example Operations

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments one or more of the operations can be performed in parallel. Moreover, some embodiments can perform more or less than all the operations shown in any flow diagram.

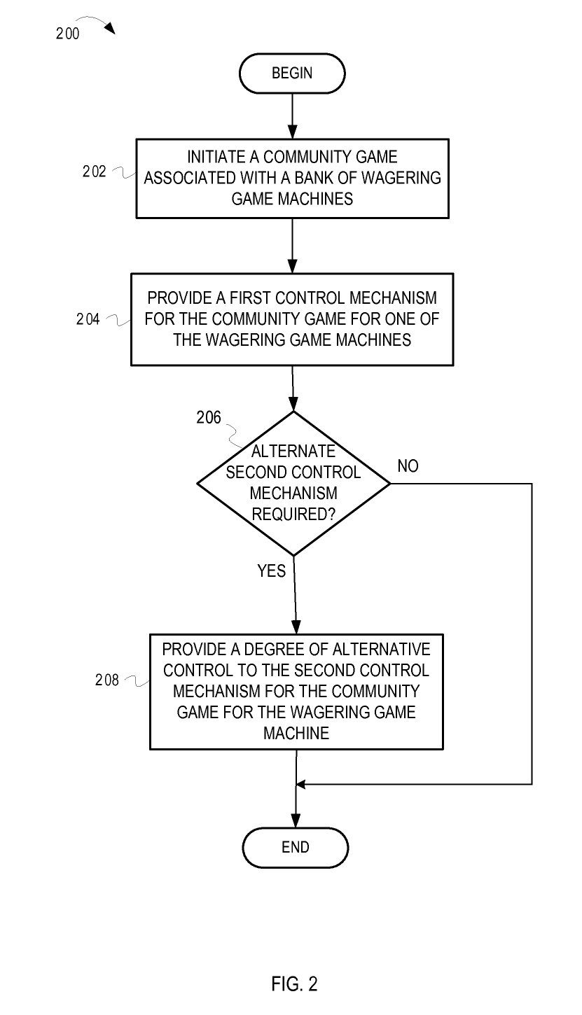

FIG. 2 is a flow diagram (“flow”) 200 illustrating providing alternate control mechanisms for a community wagering game, according to some embodiments. In FIG. 2, the flow 200 begins at processing block 202, where a wagering game system (“system”) initiates a community game associated with a bank of wagering game machines. For example, as shown in FIG. 1, the bank of wagering game machines 161-163 individually presents, at each of the wagering game machines 161-163, wagering games, either of the same theme or of different themes, which are collectively eligible to trigger a community game and/or make a player eligible for participation in the community game. In the example of FIG. 1, the community game matches a theme associated with the wagering game machines 161-163 (e.g., the REEL'EM IN® wagering game by WMS Gaming Inc.). In other embodiments, however, the community game does not match the theme, or only partially includes the theme, of the primary game(s) presented via the wagering game machines 161-163. In some embodiments, prizes available via the community game are funded, at least in part, by wagers made via the wagering game machines 161-163. In other embodiments, however, the prizes are funded by marketing funds, or other sources. In some embodiments, the community game provides prizes that are unavailable via normal play of the primary game(s) presented via the wagering game machines 161-163. The prizes can be monetary and non-monetary.

Referring again to FIG. 2, the flow 200 continues at processing block 204 wherein the system provides a first control mechanism for the community game for one of the wagering game machines. In some embodiments, the first control mechanism is a hand-held controller device (“hand-held device”), also referred to as a mobile controller. In some embodiments, the hand-held device (e.g., a wand) is connected to the wagering game machine via a tether. In some embodiments, an electrical connection in the tether communicates input data for the wand to a controller for the community wagering game, such as a wagering game server. In other embodiments, the hand-held device is not connected to the wagering game machine, but is associated with the wagering game machine. For example, the hand-held device may be at a separate playing station next to, or near, the wagering game machine. Control for the hand-held device corresponds to the wagering game machine or a player of the wagering game machine.

In some embodiments, the hand-held device includes a tracking unit that detects a movement of the hand-held device in three-dimensional physical space (3D physical space) relative to a given reference point and transmits the data to a game control unit for the community game. In other embodiments, the hand-held device includes sensing components that work in conjunction with transmitting components located in a wagering game machine to which the hand-held device is associated. For example, the hand-held device may include three, mutually orthogonally positioned sensing coils within a tip of the hand-held device. The three orthogonally positioned sensing coils correspond to the three spatial dimensions of three-dimensional physical space (i.e., the x, y, and z planes associated with a three-dimensional coordinate system). The sensing coils are configured to sense an electromagnetic field generated by a corresponding set of three mutually orthogonal transmitting coils included in the wagering game machine, or in some other fixed location near the hand-held device. The hand-held device then communicates differences of position sensed by the sensing coils relative to the transmitting coils. U.S. Patent Application No. 61/832,550 describes details related to a hand-held device similar to that described above and is hereby incorporated by reference.

In some embodiments, the system determines a position of the hand-held device in 3D physical space and uses the position of the hand-held device in 3D physical space to correspond to a location of a virtual object in 3D virtual space. Thus, a player can move the hand-held device to move virtual objects presented in the community game. For example, the system presents a virtual fishing rod and fishing line. A player can move the hand-held device in a forward, arcing movement (i.e., in a direction facing the display 140 depicted in FIG. 1) to control movement of the virtual fishing rod. The player can use buttons on the hand-held device to release a virtual fishing line on the virtual fishing rod. The system can utilize a force of the motion of the hand-held device in the forward direction to control a distance that the virtual fishing line is cast into a virtual lake presented on the display 140. When the display 140 indicates that a virtual fish has attached to the virtual fishing line, the player can move the hand-held device in a backward or jerking motion to reel in a virtual fish using the virtual fishing rod. The virtual fish can have a prize value associated with it, which is awarded to the player (e.g., is added to a session credit balance for the player's wagering game session). A fishing game is only one type of game. The system can present other types of games, with other types of virtual objects and various virtual rules of motion and physics. Some examples may include, but are not limited to, moving the hand-held device to simulate steering a virtual vehicle or craft, moving the hand-held device to simulate playing a virtual musical instrument, moving the hand-held device to simulate the swinging of a virtual bat or club, using the hand-held device to point a virtual beam or aim a virtual barrel, and so forth.

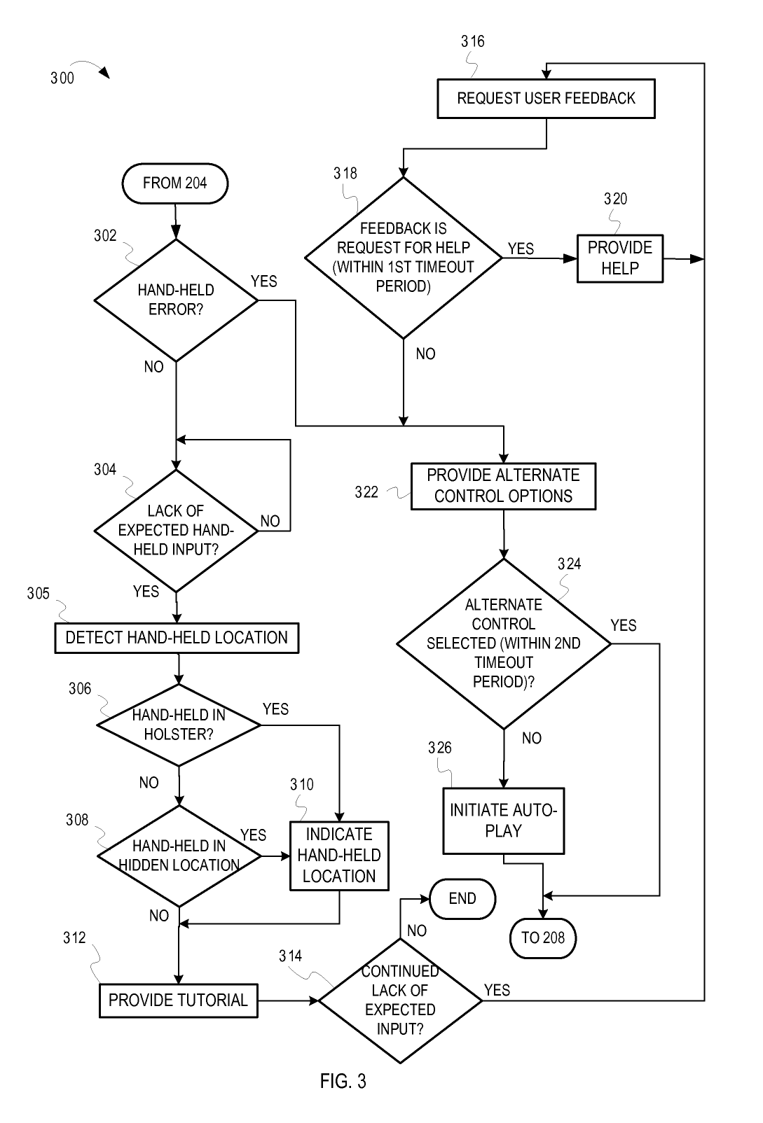

Referring again to FIG. 2, the flow 200 continues at processing block 206 where the system determines whether a second control mechanism will be used in the community game as an alternative to the first control mechanism. In some embodiments, the system detects whether the first control mechanism malfunctions or cannot be used. If the first control mechanism malfunctions, then the system must provide a replacement control mechanism so that the community game can continue. In some embodiments, the primary control mechanism does not malfunction, but a player may not want to use the first control mechanism. In such a case, the system can incentivize the player to use the first control mechanism, such as by providing tutorials, explanations of benefits, or offers for specific rewards. In other embodiments, the system can provide an alternative control mechanism for the player to use instead of the first control mechanism. FIG. 3 illustrates one embodiment for determining whether a second control mechanism will be used in the community game. FIG. 3 will be described in more detail further below.

Referring still to FIG. 2, the flow 200 continues at processing block 208 where the system provides a degree of alternative control to the second control mechanism for the community game based on determination of whether the second control mechanism will be used in the community game as the alternative to the first control mechanism. For example, if the system determines that the second control mechanism for the community based game is to be used instead of the first control mechanism, the system transfers control for the community game, associated with the wagering game machine, to the second control mechanism. The system, thus, enables the second control mechanism to control at least a portion of game play in the community game as an alternative to the first control mechanism. For instance, in FIG. 1, a primary control mechanism (e.g., hand-held device 115) failed to work. Consequently, the system 100 transferred control of the community game, for the player associated with wagering game machine 162, to another control mechanism, such as a button panel on the wagering game machine 162. In some embodiments, the system 100 may first detect whether a redundant hand-held device (e.g., hand-held device 114) is operational and can be used instead of the wand device 115. In other examples, however, although the redundant hand-held device 114 may be operational, it may not be convenient for use because of its position on the left-hand side of wagering game machine 162. The system 100 detects preferences for the player associated with wagering game machine 162 to determine whether the player is right-handed or left-handed. If the player is not left-handed, the system 100 may provide options for the player to either use the hand-held device 114 or to select one or more other controls, such as a touch screen or a button panel on the wagering game machine 162. In other embodiments, a player may request to utilize a different control mechanism even if the hand-held devices 114 and 115 are both operational. In yet other embodiments, the system 100 may provide options to use either of the hand-held devices 114 or 115 to perform some control operations and use a second control mechanism to perform other control operations. Thus, the system 100 may transfer a portion of the control to the second control mechanism (e.g., transfer some controls to the button panel of wagering game machine 162), yet retain a portion of the control with the first control mechanism (i.e. retain some controls with the hand-held device 114 and/or hand-held device 115). FIG. 3 below provides additional details.

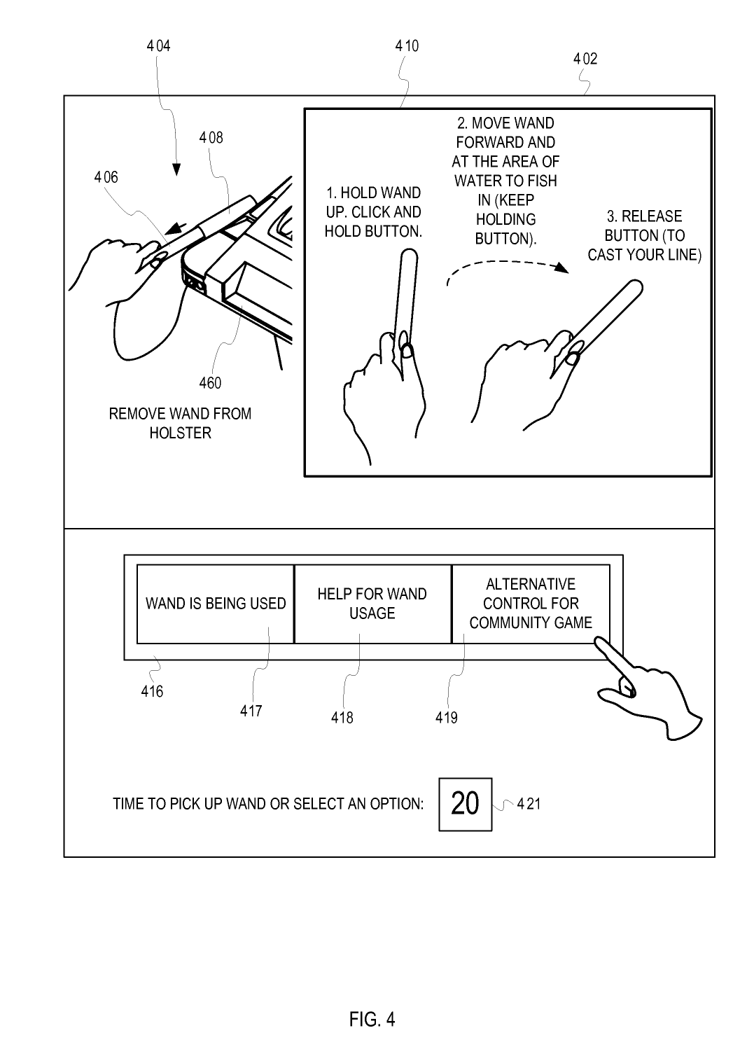

FIG. 3 is a flow diagram (“flow”) 300 illustrating determining whether alternate control mechanisms are required for a community wagering game, according to some embodiments. FIGS. 4, 5, and 6 are conceptual diagrams that help illustrate the flow of FIG. 3, according to some embodiments. This description will present FIG. 3 in concert with FIGS. 4, 5 and 6. In FIG. 3, the flow 300 begins (after processing block 204 of FIG. 2) at processing block 302, where a wagering game system (“system”) detects whether an error message occurs to indicate that the hand-held device is malfunctioning. For example, a service is running on the system that polls data for the hand-held device. The service can poll for a location of a hand-held device in 3D physical space such as via use of a motion indicator (e.g., gyroscope, location sensing coils, etc.) in the hand-held device (e.g., detects whether hand-held device is in holster or detects movement of hand-held device). In another instance, the service polls for button presses on the hand-held device. In some examples, the system may detect an error based on the polling data. For example, the system can detect that only two dimensions of movement are detected (e.g., a motion tracking mechanism is non-functional for one of the three dimensions associated with 3D physical space). In another example, the system can detect that input data for a button on the hand-held device indicates that the button is stuck in an active state. In another example, the system can detect that only one button is being pressed when both buttons are expected to be used. Furthermore, in some embodiments, the system can send test signals to the hand-held device or query the hand-held device in certain ways to determine whether certain elements are non-functional.

In some embodiments, the system detects whether a malfunction is related to input control. For example, the malfunction may only be related to output/feedback data, such as lights or a shaker motor on the hand-held device, which does not limit the use of the hand-held device for input.

If the system detects an input error for the hand-held device, the flow continues at processing block 322. If the system does not detect an error, the flow 300 continues at processing block 304. At processing block 304, the system detects a lack of expected input data associated with the hand-held device. For example, the polling service mentioned previously may be expecting, but does not receive, input data within a given time period or within a certain number of polling periods. The system, thus, fails to detect expected data. In some embodiments, when the system fails to detect expected data, the system does not immediately assume a malfunction of the hand-held device. The system does not immediately assume a malfunction for one or more reasons. For example, a player may not be able to find the hand-held device. In another example, the player may be hesitant to use the hand-held device without further instructions. In yet another example, the player may have decided not to use the hand-held device and instead desires to use an alternative control mechanism. If the system does not detect an error (i.e., at processing block 302) and if the system does not detect a lack of expected data (e.g., the polling service has not yet reached a specific time period or polling threshold), the system can repeat processing block 304 as shown.

If, however, the system detects a lack of expected data, the flow 300 continues at processing block 305, where the system detects a location of the hand-held device. For example, at processing block 306, the system detects whether the hand-held device is in a holster, or default holding receptacle. If the system detects that the hand-held device is in its holster, the flow 300 continues at processing block 310 where the system indicates the location of the hand-held device in the holster. For example, in FIG. 4, the system presents, via a display 402, a graphical depiction 404 of the hand-held device 406 in its holding receptacle (e.g., in its holster 408) at the side of wagering game machine 460. In some embodiments, the system presents the graphical representation 404 of the hand-held device 406 from the perspective of the player (e.g., from a viewing perspective of a player at the wagering game machine 460).

Returning to the discussion of FIG. 3, at processing block 306, if the system detects that the hand-held device is not in its holster, the flow continues at processing block 308, where the system determines whether the hand-held device is in a location that is hidden, or in other words, not readily visible to the player. For example, the hand-held device may have fallen to the side of or behind a wagering game machine, to the floor next to the wagering game machine, between wagering game machines in a bank, etc. In some embodiments, the system may detect that the hand-held device is above a wagering game machine, or positioned within a crevice of the wagering game machine. The system, thus, determines that the hand-held device is in a hidden location. Consequently, the flow 300 continues at processing block 310 where the system indicates the location of the hand-held device. For example, in some embodiments, the system can present a graphical representation of the location of the hand-held device in relation to the wagering game machine and/or in relation to the bank of wagering game machines. For example, if the wagering game machine is the last wagering game machine to the right in the bank, then the system can show a graphic showing the wagering game machine as the last wagering game machine to the right in the bank. In some embodiments, the system can detect and show other characteristics of the surrounding area (e.g., the system can show a location of an overhead display relative to where the player is at, or the system can show details according to an eye level of the player).

If the system determines that the hand-held device is neither in a holster nor in a hidden location (e.g., the system determines that the hand-held device is in a readily viewable location), the flow 300 continues at processing block 312, where the system provides a tutorial. For example, in FIG. 4, the system presents a tutorial 410 that indicates instructions on how to use the hand-held device to control virtual objects in the community game. In some embodiments, the system can present the tutorial 410 from the perspective of the player relative to the bank.

Returning to the discussion of FIG. 3, the flow 300 continues at processing block 314, where, after showing the tutorial, the system determines whether there is a continued lack of expected input for the hand-held device. For instance, the system again waits a given time period or polling period for expected input data from the hand-held device. If, during the time period and/or polling period, the system detects that the hand-held device begins to be used as expected, the flow 300 ends. However, if there is a continued lack of expected input, the flow 300 continues at processing block 316 where the system requests user feedback from the player. For example, as in FIG. 4, the system requests feedback from the player via various options 416. For example, the options 416 include a first option 417 whereby a player can specify that the player is currently using the hand-held device The system presents a second option 418 whereby a player can request additional help for the hand-held device, such as to repeat the tutorial 410, or provide additional help tips (e.g., additional tutorials, information about the community game, etc.). The options 416 can also include a third option 419 whereby a player can select alternative controls for the community game.

The system can further present a timer 421 by which time the player must respond (by which the player must pick up the hand-held device and being using it for the community game or by which the player must select one of the option 416).

Referring back to FIG. 3, at processing block 318, the system detects the type of feedback provided. For example, if the feedback is a request for help, within a first time out period, then the flow 300 continues at processing block 320 where the system provides the additional help and returns to processing block 316. However, at processing block 318, if the feedback is something other than a request for help, the flow continues at processing block 322. For example, in FIG. 4, if the user selects the second option 418, and if the timeout period has not occurred (e.g., if the timer 421 has not completed its countdown), then the system can provide additional help options. In some embodiments, the system can suspend the countdown during presentation of the help options and/or add time to the countdown of the timer 421. However, in some embodiments, the system has an ultimate time limit within which the player must respond to prevent delay the presentation of the community game.

If, on the other hand, the user selects the first option 417 and the system continues to fail to detect an expected input from the hand-held device, then the system determines that the hand-held device is non-functional, and, therefore, provides alternative options for controlling the community game other than by the hand-held device. If the user selects the third option 419 prior to the timeout period occurring, then the system immediately provides options for alternative control mechanisms.

If at any time within the timeout period, the player begins using the hand-held device, (e.g., the system detects removal of the hand-held device from a holster or if the system detects that the hand-held device is activated by pressing of a control button on the hand-held device), then the system can stop requesting user feedback and begin using the hand-held device as the player's specific control mechanism for the community game. Furthermore, if the timeout period occurs, the system can stop asking for user feedback and provide alternate options for the player or select an alternate option for the player (e.g., initiate an auto-play feature).

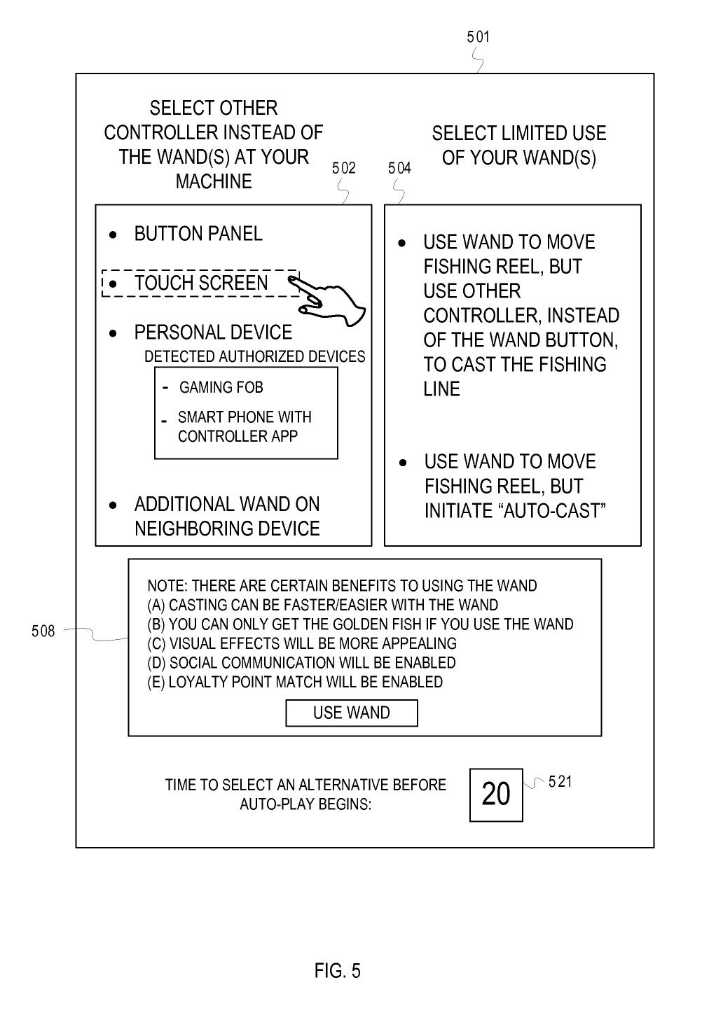

Returning momentarily to FIG. 3, at processing block 322 the system provides options for alternate controls for the community game. FIG. 5 illustrates an example. In FIG. 5, a display 501 presents first alternate control options 502 for a player to select. In some embodiments, the alternate control options include, but are not limited to a button panel associated with a wagering game machine, a touch screen for the wagering game machine, a hand-held device on a neighboring wagering game machine, and, if wireless devices are authorized for use in a casino, a personal hand-held device. The first alternate control options 502 refer to control mechanisms for the community game that can be used instead of the hand-held device assigned to the wagering game machine. Second alternate control options 504 are used to combine the use of the hand-held device with an additional control mechanism. The system further can provide an additional timer 521 to specify a countdown in a second timeout period. In some embodiments, the player must make a selection within the second timeout period otherwise the system will select an auto-play feature for the player.

In some embodiments, the system can further provide information 508 that describes one or more benefits and/or incentives to using the hand-held device. One example of a benefit or incentive includes providing, in the community game, enhanced visual effects when the hand-held is used. Another example of a benefit or incentive includes describing that play in the community game may be faster or easier when the hand-held is used instead of with alternate control devices. Another example of a benefit or incentive includes, depending on the jurisdiction, providing mathematical incentives to using the hand-held device. For instance, if a jurisdiction permits a change in an expected payback value for a wagering game, the system can change the expected payback value based on the use of the hand-held device. If the jurisdiction does not permit a change to an expected payback value, the system can instead provide incentives of more payout features when using hand-held device, provide increased payouts when using hand-held device, provide different game outcomes, provide increased volatility in the wagering game, etc. For instance, in some embodiments, the system can offer different types of game outcomes, such as a higher volatility of payback in the game. For example, the game can stock a virtual lake with different types of virtual fish having a wider range of monetary values (e.g., offer a virtual golden-fish option when a hand-held device is used, which provides for a payout potential at a high-end of a volatility range for payout). Without using the hand-held device, however, the system may only provide an average payout volatility (e.g., the player would not have the option of catching the virtual golden-fish, but can still catch virtual fish with lesser payout values). In yet other embodiments, the system can offer non-game incentives, such as, but not limited to, social communication features, side-betting features, loyalty points, etc.

Returning momentarily to FIG. 3, at processing block 324, if the player does not select an alternate control mechanism within the second timeout period, the flow 300 continues at processing block 326 where the system initiates an auto-play feature and then continues to processing block 208 of FIG. 2. If the player selects an alternate control within the second timeout period, then the flow 300 continues to processing block 208 of FIG. 2.

In some embodiments, if the player has selected an alternate control device for the second control mechanism, the system transfers entire control for the player in the community wagering game to the alternate control device. The system can provide instructions regarding use of the alternate control device. For example, for the fishing game, if the user selects the button panel or touch-screen, the system can provide multiple options (e.g., screen options, button options) regarding where to cast the virtual fishing line. FIG. 6 illustrates an example. In FIG. 6, the system presents, via a display 602 of a wagering game machine 662, touch-screen controls 610 for controlling a location where a virtual fishing line 612 should be cast into a virtual lake 616 presented via a communal display 640 for the community game. For example, in the fishing game, the system provides options for casting the virtual fishing line 612 to one of six different locations in the virtual lake 616 (e.g., a short cast to left, a mid-range cast to the left, a far cast to left, a short cast to the right, a mid-range cast to the right and a far cast to the right.). In some embodiments, the system can show an animated tutorial that shows what happens when the user selects one of the multiple options. In some embodiments, the system can provide an option to practice using the alternative device before the community game begins.

As described previously, in some embodiments, a first hand-held device at a first wagering game machine may be non-functional and, as a result, the system provides an option for the player to use a second hand-held device attached to a second wagering game machine adjacent to the first wagering game machine. Thus, the system transfer control of the community game, for the player, to the second hand-held device attached to the second wagering game machine. In some embodiments, if the second wagering game machine is associated with a second player for the community game, the system can first determine whether the second player is using the second hand-held device. For instance, if the second wagering game machine has two hand-held devices (e.g., a right-hand device and a left-hand device) the system can determine whether the second player is using one of the hand-held devices that is closest to the first wagering game machine.

In some embodiments, in response to transferring control to the second hand-held device, the system deactivates lighting on the first hand-held device and activates lighting on the second hand-held device in a way to indicate that it is now assigned to the first wagering game machine. For example, the system can generate a notification message via a display on the first wagering game machine to pick up the second hand-held device available for use at the second wagering game machine. The system can present a graphical depiction of the location of the second hand-held device from the perspective of the player relative to the location of the second hand-held device. For instance, as shown in FIG. 6, the first wagering game machine 661 has a hand-held device 606 that is not functional. The system determines that the wagering game machine 662 (situated to the immediate right of wagering game machine 661), has a left-hand hand-held device 607 that is not being used by the player at the wagering game machine 662. The system notifies the player, via a notification 630, to pick up and use the hand-held device 607.

In another example, in response to transferring control to the second hand-held device 607, the system can modify properties of the second hand-held device 607. For instance, the first wagering game machine 661 has blue emotive lighting (to specify assignment of the first wagering game machine 661 to a first character in the community game). The system, therefore, causes the color of lighting on the hand-held device 607 to also be blue. In some embodiments, if the second wagering game machine 662 is assigned a different color in the community game (e.g., the color red) as opposed to the color assigned to the first wagering game machine 661 (e.g., the color blue), the system can make the color of lighting on a hand-held device 608 to be red, while changing the lighting color of the hand-held device 607, used by the player at the first wagering game machine 661, to be blue.

Returning to the description of FIG. 2, at processing block 208 if a user selects a second control mechanism as a hybrid controller, the system can transfer part of control to second control mechanism while retaining a portion of control for the first control mechanism. For example, the system may determine that a player wants to use the hand-held device to select a location of a virtual lake into which to cast a virtual fishing line, but wants to use a button on the button panel to indicate when to release or reel in the line. Therefore, the system maintains motion control for the virtual fishing rod with the hand-held device, but transfers control of casting the virtual line away from buttons on the hand-held to one or more buttons on the button panel.

In another example of a hybrid controller, the system may detect an indication by a player to use the hand-held device to select a location of a virtual lake into which to cast a virtual fishing line, but the indication also indicates that the reeling-in of the virtual line should be done automatically. Therefore, the system maintains motion control for the virtual fishing rod with the hand-held device, but transfers control of automatic releasing and reeling-in of the virtual fishing line to an auto-play feature.

### Example Operating Environments

This section describes example operating environments and networks and presents structural aspects of some embodiments.

### Example Wagering Game System for a Community Wagering Game

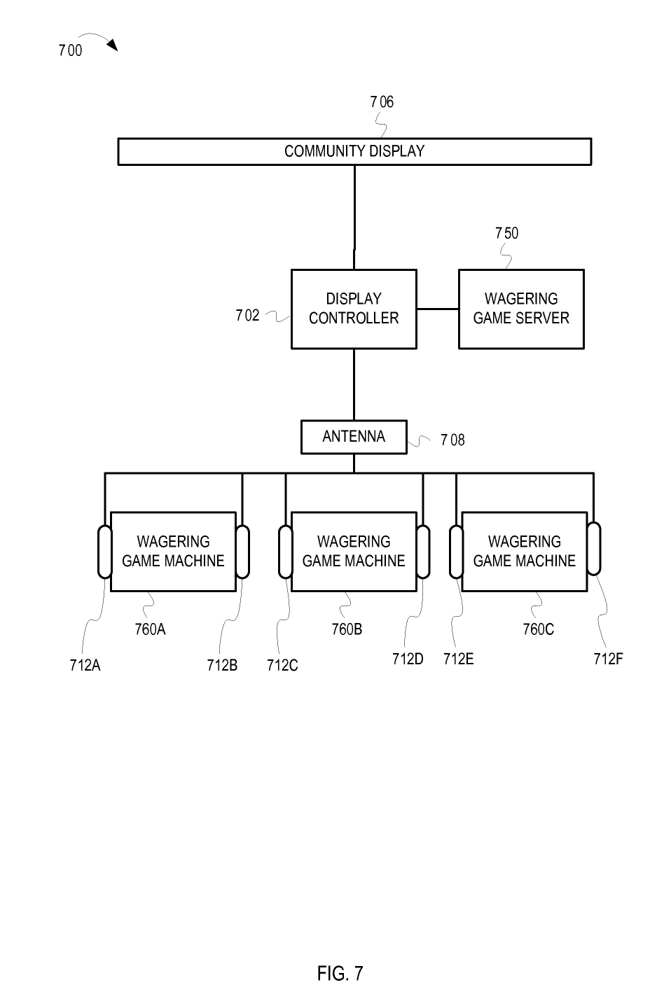

FIG. 7 is a conceptual diagram that illustrates an example of a wagering game system (“system”) 700 used for a community wagering game, according to some embodiments. In FIG. 7, the system 700 includes a display controller 702 that is communicatively coupled to a community display device 706. The display controller 702 is also communicatively coupled to a wagering game server 750 and an antenna 708. The antenna 708 is communicatively coupled to handheld devices 712A-712F. The system 700 includes a bank of wagering game machines 760A-760C. The handheld devices 712A and 712B are associated with the wagering game machine 760A. The handheld devices 712C and 712D are associated with the wagering game machine 760B. The handheld devices 712E and 712F are associated with the wagering game machine 760C. The handheld devices 712A-714F can be used by wagering game players for play of a community game that is being displayed (as described above).

During play of the community game, the wagering game server 750 provides game data for the community game to the display controller 702. The display controller 702 uses the game data to create video frames of the community game for display on the community display device 706. The display controller 702 also receives data from the antenna 708 and the handheld devices 712A-712F. The data received from the antenna 708 represent activity (e.g., position and button presses) of the handheld devices 712A-712C that occurs during play of the community game. The display controller 702 integrates the data that represents the handheld device activity with the game data from the community game server 704 to create video frames. The video frames includes the handheld device activity. The video frames are provided for presentation of the community game on the community display device 706.

The display controller 702 also includes functionality to record the data that represents handheld device activity. In some embodiments, the display controller 702 can subsequently use the recorded data to replay a community game that was previously displayed.

### Wagering Game System Architecture

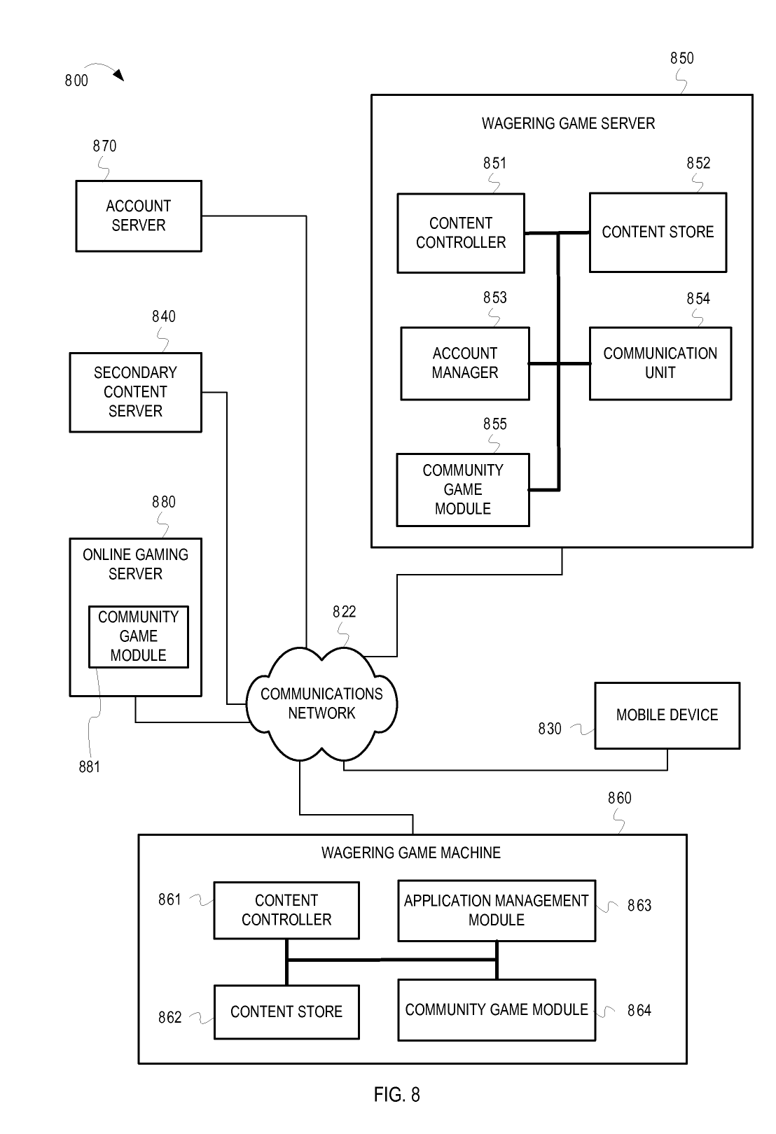

FIG. 8 is a conceptual diagram that illustrates an example of a wagering game system architecture 800, according to some embodiments. The wagering game system architecture 800 can include an account server 870 configured to control user related accounts accessible via wagering game networks and social networking networks. The account server 870 can store wagering game player account information, such as account settings (e.g., settings related to group games, etc., settings related to social contacts, etc.), preferences (e.g., player preferences regarding content presentable via an application of a mobile device, player preferences regarding award types, preferences related to virtual assets, etc.), player profile data (e.g., name, avatar, screen name, etc.), and other information for a player's account (e.g., financial information, account identification numbers, virtual assets, social contact information, etc.). The account server 870 can contain lists of social contacts referenced by a player account. The account server 870 can also provide auditing capabilities, according to regulatory rules. The account server 870 can also track performance of players, machines, and servers. The account server 870 can also track customer loyalty points, status information, etc. associated with a customer loyalty program.

The wagering game system architecture 800 can also include a wagering game server 850 configured to control wagering game content, provide random numbers, and communicate wagering game information, account information, and other information to and from a wagering game machine 860. The wagering game server 850 can include a content controller 851 configured to manage and control content for presentation on the wagering game machine 860. For example, the content controller 851 can generate game results (e.g., win/loss values), including win amounts, for games played on the wagering game machine 860. The content controller 851 can communicate the game results to the wagering game machine 860. The content controller 851 can also generate random numbers and provide them to the wagering game machine 860 so that the wagering game machine 860 can generate game results. The wagering game server 850 can also include a content store 852 configured to contain content to present on the wagering game machine 860. The wagering game server 850 can also include an account manager 853 configured to control information related to player accounts. For example, the account manager 853 can communicate wager amounts, game results amounts (e.g., win amounts), bonus game amounts, etc., to the account server 870. The wagering game server 850 can also include a communication unit 854 configured to communicate information to the wagering game machine 860 and to communicate with other systems, devices and networks. The wagering game server 850 can also include a community game module 855 configured to control a community game associated with a bank of wagering game machines.

The wagering game system architecture 800 can also include the wagering game machine 860 configured to present wagering games. The wagering game machine 860 can include a content controller 861 configured to manage and control content and presentation of content on the wagering game machine 860. The wagering game machine 860 can also include a content store 862 configured to contain content to present on the wagering game machine 860. The wagering game machine 860 can also include an application management module 863 configured to manage multiple instances of gaming applications. For example, the application management module 863 can be configured to launch, load, unload and control applications and instances of applications. The application management module 863 can launch different software players (e.g., a Microsoft® Silverlight™ player, an Adobe® Flash® player, etc.) and manage, coordinate, and prioritize what the software players do. The application management module 863 can also coordinate instances of server applications in addition to local copies of applications. The application management module 863 can control window locations on a wagering game screen or display for the multiple gaming applications. In some embodiments, the application management module 863 can manage window locations on multiple displays including displays on devices associated with and/or external to the wagering game machine 860 (e.g., a top display and a bottom display on the wagering game machine 860, a peripheral device connected to the wagering game machine 860, a mobile device connected to the wagering game machine 860, etc.). The application management module 863 can manage priority or precedence of client applications that compete for the same display area. For instance, the application management module 863 can determine each client application's precedence. The precedence may be static (i.e. set only when the client application first launches or connects) or dynamic. The applications may provide precedence values to the application management module 863, which the application management module 863 can use to establish order and priority. The precedence, or priority, values can be related to tilt events, administrative events, primary game events (e.g., hierarchical, levels, etc.), secondary game events, local bonus game events, advertising events, etc. As each client application runs, it can also inform the application management module 863 of its current presentation state. The applications may provide presentation state values to the application management module 863, which the application management module 863 can use to evaluate and assess priority. Examples of presentation states may include celebration states (e.g., indicates that client application is currently running a win celebration), playing states (e.g., indicates that the client application is currently playing), game starting states (e.g., indicates that the client application is showing an invitation or indication that a game is about to start), status update states (e.g., indicates that the client application is not ‘playing’ but has a change of status that should be annunciated, such as a change in progressive meter values or a change in a bonus game multiplier), idle states (e.g., indicates that the client application is idle), etc. In some embodiments, the application management module 863 can be pre-configurable. The system can provide controls and interfaces for operators to control screen layouts and other presentation features for the configuring of the application management module 863. The application management module 863 can communicate with, and/or be a communication mechanism for, a base game stored on a wagering game machine. For example, the application management module 863 can communicate events from the base game such as the base game state, pay line status, bet amount status, etc. The application management module 863 can also provide events that assist and/or restrict the base game, such as providing bet amounts from secondary gaming applications, inhibiting play based on gaming event priority, etc. The application management module 863 can also communicate some (or all) financial information between the base game and other applications including amounts wagered, amounts won, base game outcomes, etc. The application management module 863 can also communicate pay table information such as possible outcomes, bonus frequency, etc. In some embodiments, the application management module 863 can control different types of applications. For example, the application management module 863 can perform rendering operations for presenting applications of varying platforms, formats, environments, programming languages, etc. For example, the application management module 863 can be written in one programming language format (e.g., JavaScript, Java, C++, etc.) but can manage, and communicate data from, applications that are written in other programming languages or that communicate in different data formats (e.g., Adobe® Flash®, Microsoft® Silverlight™, Adobe® Air™, hyper-text markup language, etc.). The application management module 863 can include a portable virtual machine capable of generating and executing code for the varying platforms, formats, environments, programming languages, etc. The application management module 863 can enable many-to-many messaging distribution and can enable the multiple applications to communicate with each other in a cross-manufacturer environment at the client application level. For example, multiple gaming applications on a wagering game machine may need to coordinate many different types of gaming and casino services events (e.g., financial or account access to run spins on the base game and/or run side bets, transacting drink orders, tracking player history and player loyalty points, etc.).

The wagering game machine 860 can also include a community game module 864 configured to provide control mechanisms for participation in a community wagering game.

The wagering game system architecture 800 can also include the secondary content server 840 configured to provide content and control information for secondary games and other secondary content available on a wagering game network (e.g., secondary wagering game content, promotions content, advertising content, player tracking content, web content, etc.). The secondary content server 840 can provide “secondary” content, or content for “secondary” games presented on the wagering game machine 860. “Secondary” in some embodiments can refer to an application's importance or priority of the data. In some embodiments, “secondary” can refer to a distinction, or separation, from a primary application (e.g., separate application files, separate content, separate states, separate functions, separate processes, separate programming sources, separate processor threads, separate data, separate control, separate domains, etc.). Nevertheless, in some embodiments, secondary content and control can be passed between applications (e.g., via application protocol interfaces), thus becoming, or falling under the control of, primary content or primary applications, and vice versa. In some embodiments, the secondary content can be in one or more different formats, such as Adobe® Flash®, Microsoft® Silverlight™, Adobe® Air™, hyper-text markup language, etc. In some embodiments, the secondary content server 840 can provide and control content for community games, including networked games, social games, competitive games, or any other game that multiple players can participate in at the same time. In some embodiments, the secondary content server 840 can control and present an online website that hosts wagering games. The secondary content server 840 can also be configured to present multiple wagering game applications on the wagering game machine 860 via a wagering game website, or other gaming-type venue accessible via the Internet. The secondary content server 840 can host an online wagering website and/or a social networking website. The secondary content server 840 can include other devices, servers, mechanisms, etc., that provide functionality (e.g., controls, web pages, applications, etc.) that web users can use to connect to a social networking application and/or website and utilize social networking and website features (e.g., communications mechanisms, applications, etc.). The secondary content server 840 can also be configured to provide content presentable via an application of the mobile device 830. In some embodiments, the secondary content server 840 can also host social networking accounts, provide social networking content, control social networking communications, store associated social contacts, etc. The secondary content server 840 can also provide chat functionality for a social networking website, a chat application, or any other social networking communications mechanism. In some embodiments, the secondary content server 840 can utilize player data to determine marketing promotions that may be of interest to a player account. The secondary content server 840 can also analyze player data and generate analytics for players, group players into demographics, integrate with third party marketing services and devices, etc. The secondary content server 840 can also provide player data to third parties that can use the player data for marketing. In some embodiments, the secondary content server 840 can provide one or more social networking communication mechanisms that publish (e.g., post, broadcast, etc.) a message to a mass (e.g., to multiple people, users, social contacts, accounts, etc.). The social networking communication mechanism can publish the message to the mass simultaneously. Examples of the published message may include, but not be limited to, a blog post, a mass message post, a news feed post, a profile status update, a mass chat feed, a mass text message broadcast, a video blog, a forum post, etc. Multiple users and/or accounts can access the published message and/or receive automated notifications of the published message.

The wagering game system architecture 800 can also include the online gaming server 880 configured to control and present a website that hosts gaming related content (e.g., monetary type wagering games, non-monetary type wagering games, social networking content related to gaming, etc.). The online gaming server 880 can be configured to present multiple applications on the website via the Internet. The online gaming server 880 can host a social network. The online gaming server 880 can include other devices, servers, mechanisms, etc., that provide functionality (e.g., controls, web pages, applications, etc.) that web users can use to connect to a social networking application and/or website and utilize social networking and website features (e.g., communications mechanisms, applications, etc.). The online gaming server 880 can also be configured to provide content presentable via an application of the mobile device 830. Furthermore, the online gaming server 880 can include a community game module 881. The community game module 881 can communicate with the community game module 855 to control community games for online player accounts. The wagering game server 850 can further link together an online gaming account with a wagering game player account.

The wagering game system architecture 800 can also include the mobile device 830 configured to control mobile communications and applications. The mobile device 830 may also be referred to as a handheld device, a handheld computer or simply handheld. In some embodiments, the mobile device 830 is a pocket-sized computing device, having a display screen with touch input and/or a miniature keyboard. Some examples of the mobile device 830 may include, but are not limited to, a smartphone, a personal digital assistant, a mobile computer, a mobile internet device, a portable media player, a mobile phone, a pager, a personal navigation device, etc. In some embodiments, the mobile device 830 functions via a wireless application protocol (WAP). In some embodiments, the mobile device 830 may include integrated data capture devices like barcode readers, radio frequency identification (RFID) readers, In-cell Optical LCD readers, and smart card readers. In some embodiments, the mobile device 830 is configured to communicate with wagering game devices, such as the wagering game server 850, the wagering game machine 860, the online gaming server 880, the secondary content server 840, and the account server 870. In some embodiments the mobile device 830 is personal (i.e., belongs to a user), which the user can carry on their person.

Each component shown in the wagering game system architecture 800 is shown as a separate and distinct element connected via a communications network 822. However, some functions performed by one component could be performed by other components. For example, the wagering game server 850 can also be configured to perform functions of the application management module 863, and other network elements and/or system devices. Furthermore, the components shown may all be contained in one device, but some, or all, may be included in, or performed by, multiple devices, as in the configurations shown in FIG. 8 or other configurations not shown. For example, the account manager 853 and the communication unit 854 can be included in the wagering game machine 860 instead of, or in addition to, being a part of the wagering game server 850. Further, in some embodiments, the wagering game machine 860 can determine wagering game outcomes, generate random numbers, etc. instead of, or in addition to, the wagering game server 850.

The wagering game machines described herein (e.g., wagering game machine 860) can take any suitable form, such as floor standing models, handheld mobile wagering game machines, bar-top models, workstation-type console models, surface computing machines, etc. Further, wagering game machines can be primarily dedicated for use in conducting wagering games.

In some embodiments, wagering game machines and wagering game servers work together such that wagering game machines can be operated as thin, thick, or intermediate clients. For example, one or more elements of game play may be controlled by the wagering game machines (client) or the wagering game servers (server). Game play elements can include executable game code, lookup tables, configuration files, game outcome, audio or visual representations of the game, game assets or the like. In a thin-client example, the wagering game server can perform functions such as determining game outcome or managing assets, while the wagering game machines can present a graphical representation of such outcome or asset modification to the user (e.g., player). In a thick-client example, the wagering game machines can determine game outcomes and communicate the outcomes to the wagering game server for recording or managing a player's account.

In some embodiments, either the wagering game machines (client) or the wagering game server(s) can provide functionality that is not directly related to game play. For example, account transactions and account rules may be managed centrally (e.g., by the wagering game server(s)) or locally (e.g., by the wagering game machines). Other functionality not directly related to game play may include power management, presentation of advertising, software or firmware updates, system quality or security checks, etc.

Furthermore, the wagering game system architecture 800 can be implemented as software, hardware, any combination thereof, or other forms of embodiments not listed. For example, any of the network components (e.g., the wagering game machines, servers, etc.) can include hardware and machine-readable storage media including instructions for performing the operations described herein.

### Wagering Game Machine Architecture

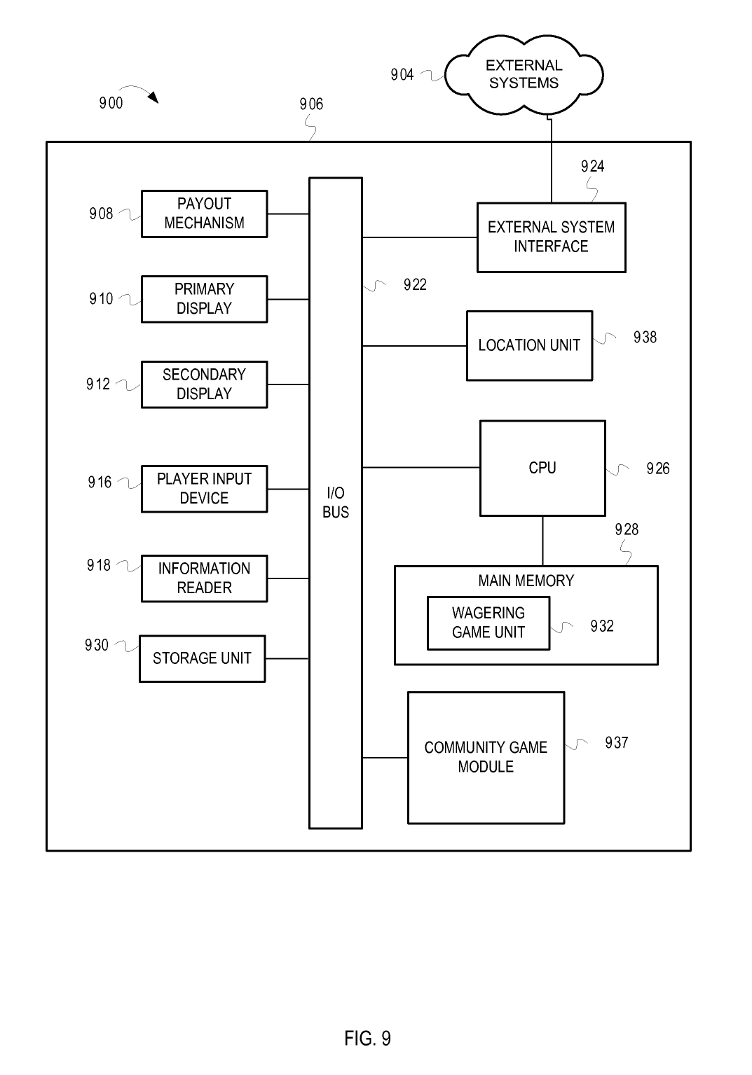

FIG. 9 is a conceptual diagram that illustrates an example of a wagering game machine architecture 900, according to some embodiments. In FIG. 9, the wagering game machine architecture 900 includes a wagering game machine 906, which includes a central processing unit (CPU) 926 connected to main memory 928. The CPU 926 can include any suitable processor, such as an Intel® Pentium processor, Intel® Core 2 Duo processor, AMD Opteron™ processor, or UltraSPARC processor. The main memory 928 includes a wagering game unit 932. In some embodiments, the wagering game unit 932 can present wagering games, such as video poker, video black jack, video slots, video lottery, reel slots, etc., in whole or part.

The CPU 926 is also connected to an input/output (“I/O”) bus 922, which can include any suitable bus technologies, such as an AGTL+frontside bus and a PCI backside bus. The I/O bus 922 is connected to a payout mechanism 908, primary display 910, secondary display 912, value input device 914, player input device 916, information reader 918, and storage unit 930. The player input device 916 can include the value input device 914 to the extent the player input device 916 is used to place wagers. The I/O bus 922 is also connected to an external system interface 924, which is connected to external systems 904 (e.g., wagering game networks). The external system interface 924 can include logic for exchanging information over wired and wireless networks (e.g., 802.11g transceiver, Bluetooth transceiver, Ethernet transceiver, etc.)

The I/O bus 922 is also connected to a location unit 938. The location unit 938 can create player information that indicates the wagering game machine's location/movements in a casino. In some embodiments, the location unit 938 includes a global positioning system (GPS) receiver that can determine the wagering game machine's location using GPS satellites. In other embodiments, the location unit 938 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 9, in some embodiments, the location unit 938 is not connected to the I/O bus 922.

In some embodiments, the wagering game machine 906 can include additional peripheral devices and/or more than one of each component shown in FIG. 9. For example, in some embodiments, the wagering game machine 906 can include multiple external system interfaces 924 and/or multiple CPUs 926. In some embodiments, any of the components can be integrated or subdivided.

In some embodiments, the wagering game machine 906 includes a community game module 937. The community game module 937 can process communications, commands, or other information, where the processing can provide control mechanisms for participation in a community wagering game.

Furthermore, any component of the wagering game machine 906 can include hardware, firmware, and/or machine-readable storage media including instructions for performing the operations described herein.

### Wagering Game System

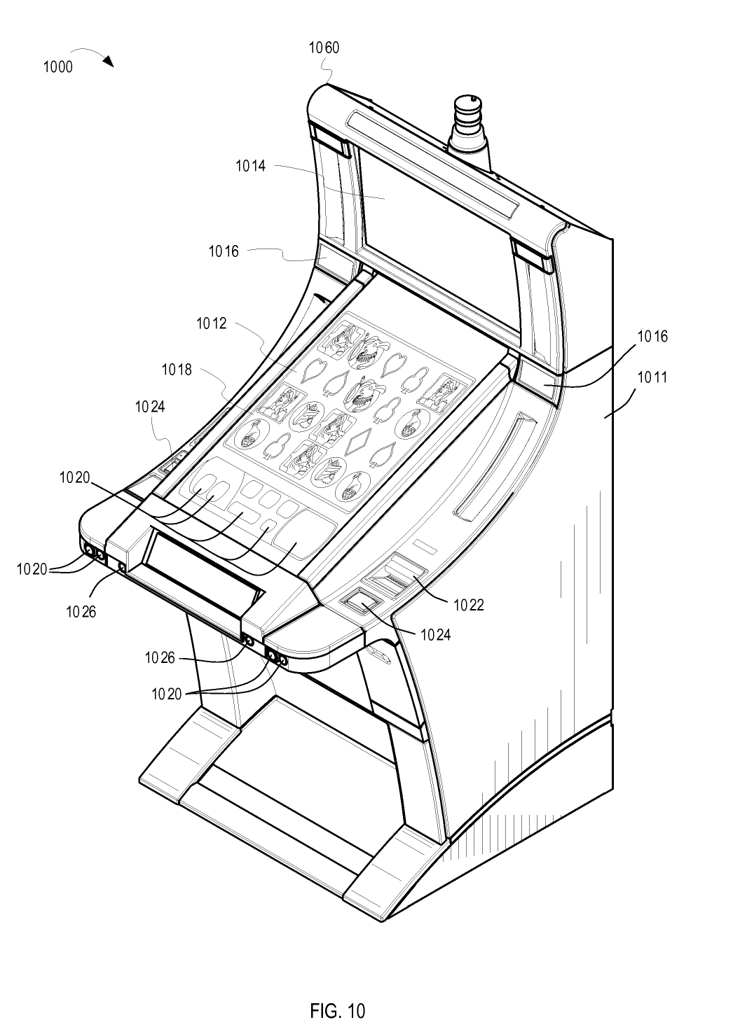

FIG. 10 is a conceptual diagram that illustrates an example of a wagering game system 1000, according to some embodiments. In FIG. 10, the wagering game system 1000 includes a wagering game machine 1060 similar to those used in gaming establishments, such as casinos. The wagering game machine 1060 may, in some examples, be referred to as a gaming terminal or an electronic gaming machine. The wagering game machine 1060 may have varying structures and methods of operation. For example, the wagering game machine 1060 may include electromechanical components configured to play mechanical slots. In another example, the 1060 includes electronic components configured to play a video casino game, such as slots, keno, poker, blackjack, roulette, craps, etc. The wagering game machine 1060 is depicted as a floor-standing model. However, other examples of wagering game machines include handheld mobile units, bartop models, workstation-type console models, etc. Further, the wagering game machine 1060 may be primarily dedicated for use in conducting wagering games, or may include non-dedicated devices, such as mobile phones, personal digital assistants, personal computers, etc. Exemplary types of wagering game machines are disclosed in U.S. Pat. No. 6,517,433 and Patent Application Publication Nos. US2010/0062196 and US2010/0234099, which are incorporated herein by reference in their entireties.

The wagering game machine 1060 illustrated in FIG. 10 comprises a cabinet 1011 that may house various input devices, output devices, and input/output devices. By way of example, the wagering game machine 1060 includes a primary display area 1012, a secondary display area 1014, and one or more audio speakers 1016. The primary display area 1012 or the secondary display area 1014 may include one or more of a cathode ray tube (CRT), a high resolution liquid crystal display (LCD), a plasma display, a light emitting diode (LED) display, a three-dimensional (3D) display, a video display, or a combination thereof. In some examples, the primary display area 1012 or the secondary display area 1014 includes mechanical reels to display a wagering game outcome. In some example, the primary display area 1012 or the secondary display area 1014 present a transmissive video display disposed in front of a mechanical-reel display to portray a video image superimposed upon the mechanical-reel display. In FIG. 10, the wagering game machine 1060 is a “slant-top” version in which the primary display 1012 is slanted (e.g., at about a thirty-degree angle toward the player of the wagering game machine 1060). Another example of wagering game machine 1060 is an “upright” version in which the primary display 1014 is oriented vertically relative to the player. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the wagering game machine 1060. The wagering game machine 1060 includes a touch screen(s) 1018 mounted over the primary or secondary areas, buttons 1020 on a button panel, bill validator 1022, information reader/writer(s) 1024, and player-accessible port(s) 1026 (e.g., audio output jack for headphones, video headset jack, USB port, wireless transmitter/receiver, etc.). It should be understood that numerous other peripheral devices and other elements exist and are readily utilizable in any number of combinations to create various forms of a wagering game machine in accord with the present concepts.

Input devices, such as the touch screen 1018, buttons 1020, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer readable program code embodied in the medium. The described embodiments may be provided as a computer program product that may include a machine-readable storage medium having stored thereon instructions, which may be used to program a computer system to perform a process according to embodiments(s), whether presently described or not, because every conceivable variation is not enumerated herein. A machine-readable storage medium includes any mechanism that stores information in a form (e.g., software, processing application) readable by a machine (e.g., a computer). For example, machine-readable storage media includes magnetic storage medium (e.g., floppy diskette), read only memory (ROM), random access memory (RAM), magnetic disk storage media, optical storage media (e.g., CD-ROM), magneto-optical storage media, flash memory, erasable programmable memory (e.g., EPROM and EEPROM), or other types of media suitable for storing electronic instructions. In addition, embodiments may be embodied in a machine-readable signal media, such as any media suitable for transmitting software over a network.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A computer-implemented method comprising:
initiating a community wagering game associated with a bank of wagering game machines, wherein a wagering game machine from the bank of wagering game machines is associated with a hand-held game controller configured to control game play for the community wagering game;
selecting, via at least one of one or more processors, a second game controller associated with the wagering game machine as an alternative to the hand-held game controller for the community wagering game; and
enabling the second game controller to control at least a portion of the game play for the community wagering game.

2. The computer-implemented method of claim 1 further comprising:
detecting a lack of expected input from the hand-held game controller after initiating the community wagering game, wherein the selecting the second game controller occurs after the detecting.

3. The computer-implemented method of claim 1 further comprising:
detecting a malfunction of the hand-held game controller, wherein the selecting the second game controller occurs after the detecting.

4. The computer-implemented method of claim 1 further comprising:
presenting a plurality of alternative control mechanisms available to control at least a portion of the game play, wherein the second game controller is included in the plurality of alternative control mechanism; and
detecting a selection of the second game controller from the plurality of alternative control mechanisms.

5. The computer-implemented method of claim 1, further comprising:
prior to the selecting the second game controller performing one or more of indicating a location of the hand-held game controller;
providing a tutorial for use of the hand-held game controller; and
indicating one or more incentives for using the hand-held game controller instead of the second game controller.

6. The computer-implemented method of claim 1 further comprising:
detecting a lack of use of the hand-held game controller within a period of time after initiating the community wagering game, wherein the selecting the second game controller occurs after the detecting the lack of use.

7. The computer-implemented method of claim 1, wherein movement of the hand-held controller in three-dimensional physical space controls corresponding movement of a virtual object for the community game in three-dimensional virtual space.

8. One or more machine-readable storage devices having instructions stored thereon, which when executed by a set of one or more processors causes the set of one or more processors to perform operations comprising:
initiating a community wagering game associated with a bank of wagering game machines, wherein a wagering game machine from the bank of wagering game machines is associated with a hand-held control device configured to control game play for the community wagering game;
detecting a request to use a second game control device associated with the wagering game machine, instead of the hand-held control device, to control at least a portion of the game play for the community wagering game; and
enabling the second game control device to control the at least the portion of the game play for the community wagering game.

9. The one or more machine-readable storage devices of claim 8, wherein the operation of detecting the request to use the second game control device comprises an operation of detecting a request to replace a first portion of functionality of the hand-held control device with functionality of the second game control device, and wherein the operation of enabling the second game control device to control the at least the portion of the game play comprises an operation of replacing the first portion of the functionality of the hand-held control device with the functionality of the second game control device.

10. The one or more machine-readable storage devices of claim 8, wherein the operation of enabling the second game control device to control the at least the portion of the game play comprises an operation of transferring control associated with a button of the hand-held control device to one or more of a button panel and a touch screen of the wagering game machine.

11. The one or more machine-readable storage devices of claim 8, wherein the operation of enabling the second game control device to control the at least the portion of the game play comprises an operation of transferring control associated with the hand-held control device to an additional hand-held control device associated with a second wagering game machine in the bank of wagering game machines.

12. The one or more machine-readable storage devices of claim 8, wherein prior to the operation of enabling the second game control device to control the at least the portion of the game play, said operations further comprising one or more of,
indicating a location of the hand-held control device,
providing a tutorial for use of the hand-held control device, and
indicating one or more incentives to use the hand-held control device instead of the second game control device.

13. A system comprising:
at least one processor; and
at least one memory device configured to store instructions which, when executed by the at least one processor, cause the system to perform operations to,
initiate a community wagering game associated with a bank of wagering game machines, wherein a wagering game machine from the bank of wagering game machines is associated with a hand-held game controller configured to control game play for the community wagering game,
detect that the hand-held game controller is not used according to a control expectation,
select a second game controller associated with the wagering game machine as an alternative to the hand-held game controller for the community wagering game, and
enable the second game controller to control at least a portion of the game play for the community wagering game.

14. The system of claim 13, where the instructions configured to cause the system to detect that the hand-held game controller is not used according to the control expectation includes instructions which, when executed by the at least one processor, cause the system to perform operations to:
poll the hand-held game controller for input data;
detect, after a given period after the community wagering game initiates, that the hand-held game controller has not provided input data; and
determine, based on detection that the hand-held game controller has not provided the input data, that the second game controller is required to replace the hand-held game controller to control the game play.

15. The system of claim 13, where the instructions configured to cause the system to detect that the hand-held game controller is not used according to the control expectation includes instructions which, when executed by the at least one processor, cause the system to perform operations to:
poll the hand-held game controller for input data;
detect that the hand-held game controller has provided one or more of only a portion of expected input data and unexpected input data; and
determine, based on detection of the one or more of the only the portion of the expected input data and the unexpected input data, that the hand-held game controller is non-functional.

16. The system of claim 13, where the at least one memory device is configured to store instructions which, when executed by the at least one processor, cause the system to further perform operations to:
present an option to select the second game controller from one or more input devices associated with the wagering game machine; and
detect selection of the second game controller from the one or more input devices.

17. The system of claim 13, where the at least one memory device is configured to store instructions which, when executed by the at least one processor, cause the system to further perform operations to one or more of indicate a location of the hand-held game controller, provide a tutorial for use of the hand-held game controller, and indicate one or more incentives to use the hand-held game controller instead of the second game controller.

18. An apparatus comprising:
at least one processor; and
at least one memory device configured to store instructions which, when executed by the at least one processor, cause the apparatus to perform operations to
detect initiation of a community wagering game associated with a plurality of wagering game machines,
after initiation of the community wagering game, detect a lack of expected input from a hand-held game controller configured to control play in the community wagering game for a wagering game machine from the plurality of wagering game machines, and
after detection of the lack of expected input, provide information related to the hand-held game controller for presentation via an output device of the wagering game machine.

19. The apparatus of claim 18, wherein the at least one memory device is configured to store instructions which, when executed by the at least one processor, cause the apparatus to perform operations to provide an indication of a location of the hand-held game controller relative to the wagering game machine.

20. The apparatus of claim 18, wherein the at least one memory device is configured to store instructions which, when executed by the at least one processor, cause the apparatus to perform operations to detect that the hand-held game controller is not in a default location.

21. The apparatus of claim 18, wherein the at least one memory device is configured to store instructions which, when executed by the at least one processor, cause the apparatus to perform operations to present a tutorial related to use of the hand-held game controller to control play of the wagering game.

22. The apparatus of claim 18, wherein the at least one memory device is configured to store instructions which, when executed by the at least one processor, cause the apparatus to perform operations to:
after providing the information related to the hand-held game controller, detect an additional lack of expected input from the hand-held game controller; and
provide one or more options to select a second game controller as an alternative to the hand-held game controller to control the play in the community wagering game.

23. The apparatus of claim 22 wherein the at least one memory device is configured to store instructions which, when executed by the at least one processor, cause the apparatus to perform operations to:
after the one or more options to select the second game controller are provided, detect expiration of a time period; and
in response to expiration of the time period, initiate an auto-play feature for the community game, wherein the auto-play feature controls the play of the community wagering game on behalf of a participant in the community wagering game associated with the wagering game machine.

24. An apparatus comprising:
means for initiating a community wagering game associated with a bank of wagering game machines, wherein a wagering game machine from the bank of wagering game machines is associated with a hand-held game controller configured to control game play, associated with the wagering game machine, for the community wagering game;
means for polling the hand-held game controller for input data;
means for detecting, after a given period after the community wagering game is initiated, that the hand-held game controller fails to provide expected input data; and
means for selecting a second game controller associated with the wagering game machine as an alternative to the hand-held game controller for the community wagering game, after detecting that the hand-held game controller failed to provide the expected input data.

25. The apparatus of claim 24, wherein the means for means for detecting, after the given period after the community wagering game is initiated, that the hand-held game controller failed to provide the expected input data comprises means for determining that the hand-held game controller has provided one or more of only a portion of expected input data and input data contrary to the expected input data.

26. The apparatus of claim 24, wherein the means for selecting the second game controller comprises:
means for detecting that a control device associated with an additional wagering game machine is not in use, wherein the additional wagering game machine is adjacent to the wagering game machine within the bank;
means for selecting the control device as the second game controller; and
means for transferring control of the game play to the control device associated with the additional wagering game machine.
